(19) United States
(12) Patent Application Publication
(10) Pub. No.: US 2008/0238052 A1
(43) Pub. Date: Oct. 2, 2008

(54) Airbag apparatus

(75) Inventors: Takashi Iida, Aichi-ken (JP); Makoto Yamanaka, Aichi-ken (JP); Yasuo Ochiai, Aichi-ken (JP); Yoshio Mizuno, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/076,868

(22) Filed: Mar. 25, 2008

(30) Foreign Application Priority Data
Mar. 29, 2007 (JP) 2007-088918

(51) Int. Cl. B60R 21/213

(52) U.S. Cl. 280/730.1

(57) ABSTRACT

An airbag apparatus has an airbag body, which is arranged between a roof panel and a roof head lining of a vehicle and held in a folded state. The airbag body also has a second bolt, a fixed piece, and a folded portion. The airbag body is fixed to a guide portion of an inner panel by the second bolt. The fixed piece is fixed by the second bolt. The folded portion extends from the fixed piece and is maintained in a folded state. The airbag body also includes a binding tape and a restricting plate. The binding tape binds the folded portion together and releases the folded portion when the airbag body is deployed and inflated. The restricting plate ensures an open space below the folded portion and restricts downward displacement of the folded portion when the airbag body 13 is fixed to the guide portion.

### BACKGROUND OF THE INVENTION

The present invention relates to an airbag apparatus having an airbag body installed between a roof panel and a roof head lining of a vehicle and held in a folded state.

Conventionally, Japanese Laid-Open Patent Publication No. 2005-104172 discloses one such type of airbag apparatus. FIG. 13 schematically shows a typical airbag apparatus for rear-end collision of a vehicle, including the apparatus of this document.

As shown in FIG. 13, the airbag apparatus for rear-end collision includes an airbag body 113 mounted between a roof panel 21 and a roof head lining 22 of a vehicle 11 and held in a folded state. In a rear end collision of the vehicle 11, an inflator 14 supplies gas to the airbag body 113, thus deploying and inflating the airbag body 113 into a space rearward from a rear seat with respect to the vehicle.

Specifically, with reference to FIG. 14, the airbag body 113 has a plurality of fixed pieces 131a, 131b, 131c, which are fixed to the roof panel 21 by bolts 132a, 132b, 132c, and a folded portion 133 extending from the fixed pieces 131a to 131c and held in a folded state. The folded portion 133 is bound together by binding tapes 135A, 135B. The folded portion 133 is thus maintained in the folded state when the airbag body 113 is mounted in the vehicle 11. The binding tapes 135A, 135B break when the airbag body 113 is deployed and inflated, thus releasing the airbag body 113 from the restricted state.

The airbag body 113 of this conventional airbag apparatus has the fixed pieces 131a to 131c and the folded portion 133. Thus, when the airbag body 113 is secured to the roof panel 21 as illustrated in FIG. 15, the folded portion 133 hangs down due to its own weight, complicating the installation of the airbag apparatus.

To solve this problem, the apparatus of Japanese Laid-Open Patent Publication No. 2005-104172 includes a lower plate 136, which is fixed to the roof panel 21 at a position below the folded portion 133 of the airbag body 113. The lower plate 136 thus prevents the folded portion 133 from hanging down. However, the lower plate 136 also prevents the airbag body 113 from being deployed inflated in a downward direction. This makes it impossible to deploy and inflate the airbag body 113 in a desired direction, which is also disadvantageous.

Such problems are common for airbag apparatuses having airbag bodies installed between roof panels and roof head linings of vehicles and held in folded states, other than airbag apparatuses for rear-end collision.

Accordingly, it is an objective of the present invention to provide an airbag apparatus that smoothly deploys and inflates an airbag body downward along an inner wall of a vehicle and suppresses downward hanging of the airbag body in the airbag apparatus in an installed state.

### SUMMARY OF THE INVENTION

To achieve the foregoing objective and in accordance with one aspect of the present invention, an airbag apparatus having an airbag body arranged between a roof panel and a roof head lining of a vehicle and held in a folded state is provided. The airbag apparatus includes a fixing member fixing the airbag body to the roof panel, a binding member, and a restricting member. The airbag body has a fixed portion fixed by the fixing member and a folded portion that extends from the fixed portion and is maintained in a folded state. The binding member binds the folded portion and releases the folded portion when the airbag body is deployed and inflated. The restricting member restricts downward displacement of the folded portion while ensuring an open space below the folded portion when the airbag body is fixed to the roof panel.

In this structure, the binding member binds the folded portion of the airbag body together, thus maintaining the airbag body in a folded state. The airbag body has the fixed portion fixed by the fixing member and the folded portion extending from the fixed portion and held in a folded state. Since the apparatus according to the present invention has the restricting member that restricts downward displacement of the folded portion, the folded portion is prevented from hanging down due to its own weight. Further, since the restricting member ensures an open space below the folded portion, downward deployment and inflation of the airbag body are prevented from being hindered by the restricting member. This allows the airbag body to be smoothly deployed and inflated downward along inner walls of the vehicle and prevents the airbag body from hanging down when the airbag apparatus is installed. If a roof head lining guides the airbag body so that the airbag body is deployed and inflated in a desired direction, inflation of the airbag body is prevented from being hindered by the restricting member.

### BRIEF DESCRIPTION OF THE DRAWINGS

FIG. 1 is a side view showing a vehicle including an airbag apparatus according to a first embodiment of the present invention;

FIG. 2 is a rear view showing the vehicle according to the first embodiment;

FIG. 3 is a cross-sectional view of the roof shown in FIG. 2, taken along line 3-3 of FIG. 2;

FIG. 4 is a perspective view showing an airbag body according to the first embodiment;

FIG. 5 is a perspective view showing a restricting plate according to the first embodiment;

FIG. 6 is an enlarged cross-sectional view mainly showing the airbag body shown in FIG. 3;

FIG. 7 is a plan view showing an airbag apparatus according to a second embodiment of the present invention;

FIG. 8 is a cross-sectional view of the airbag apparatus shown in FIG. 7, taken along line 8-8;

FIG. 9 is a cross-sectional view (corresponding to FIG. 4) showing an airbag apparatus according to a third embodiment of the present invention;

FIG. 10 is a perspective view showing an airbag apparatus according to a fourth embodiment of the present invention;

FIG. 11 is a plan view showing a modification of the airbag apparatus according to the present invention;

FIG. 12 is a plan view showing another modification of the airbag apparatus according to the present invention;

FIG. 13 is a cross-sectional view showing a conventional airbag apparatus;

FIG. 14 is a perspective view showing the conventional airbag apparatus; and

FIG. 15 is a cross-sectional view illustrating a folded portion of the conventional airbag apparatus hanging down.

### DETAILED DESCRIPTION OF THE PREFERRED EMBODIMENTS

### First Embodiment

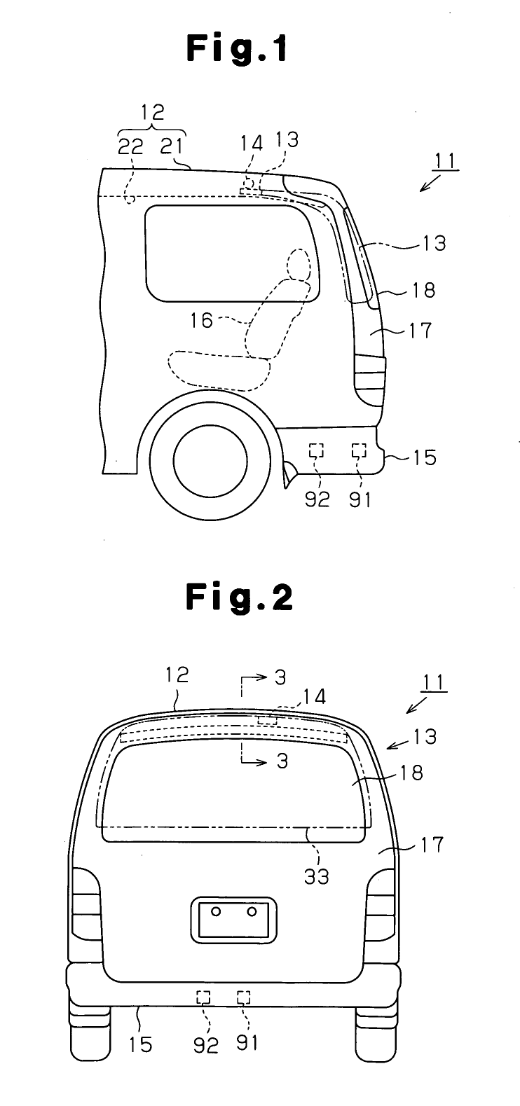

A first embodiment of an airbag apparatus according to the present invention, which is an airbag apparatus for rear-end collision secured to a minivan or a hatchback, will hereafter be described with reference to FIGS. 1 to 6.

As shown in FIGS. 1 and 2, an airbag apparatus for rear-end collision including an inflator 14 and an airbag body 13 is secured to a rear portion of a roof 12 of a vehicle 11. The inflator 14 generates gas to deploy and inflate the airbag body 13. The airbag body 13 is arranged rearward from the inflator 14 and held in a folded state.

A sensor 91 detecting impact from the rear of the vehicle 11 and a controller 92 are provided in a rear bumper 15 of the vehicle 11. The controller 92 outputs an actuation signal commanding the inflator 14 to generate gas in accordance with a detection result of the sensor 91. If a rear-end collision happens, the inflator 14 generates the gas in response to the actuation signal. This deploys and inflates the airbag body 13 along a window glass 18 of a rear door 17 at a position rearward from a head rest of a rearmost seat 16, as indicated by the double-dotted chain lines in FIGS. 1 and 2.

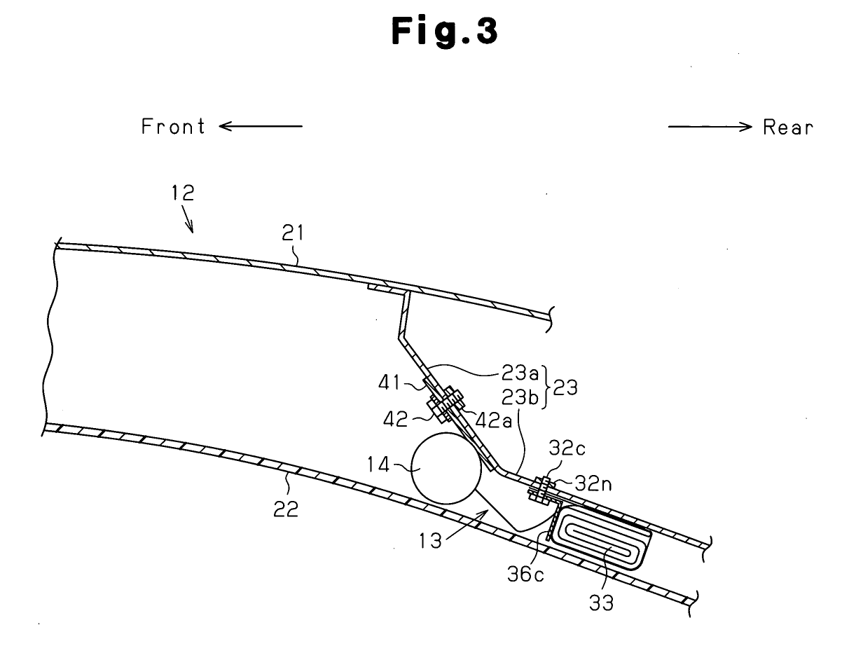

The airbag apparatus and a securing structure of the airbag apparatus will hereafter be explained with reference to FIGS. 3 to 6.

As shown in FIG. 3, a roof 12 has a flat plate-like roof panel 21 and a flat plate-like roof head lining 22. The roof panel 21 extends in the front-and-rear direction of the vehicle 11. The roof head lining 22 extends in the front-and-rear direction of the vehicle 11 along and below the roof panel 21. The roof panel 21 is formed by a plate of steel and forms an exterior component of the vehicle 11. The roof head lining 22 is formed of synthetic resin and constitutes the ceiling surface of the vehicle. A front end of an inner panel 23 is fixed to the lower surface of the roof panel 21 to enhance rigidity of a rear portion of the roof 12.

The inner panel 23 is formed by bending a plate of steel. The inner panel 23 has a slanted portion 23a and a guide portion 23b. The slanted portion 23a extends from the roof panel 21 toward the roof head lining 22 and diagonally rearward at a predetermined angle. The guide portion 23b is bent at an obtuse angle at the rear end of the slanted portion 23a and extends in the front-and-rear direction of the vehicle 11. The inflator 14 is fixed to the slanted portion 23a by a first bolt 42 and a nut 42a through a bracket 41 and located forward from the slanted portion 23a. The airbag body 13 is fixed to the guide portion 23b by second bolts 32a, 32b, 32c and nuts 32n through a plurality of fixed pieces 31a, 31b, 31c. The airbag body 13 is arranged between the guide portion 23b and the roof head lining 22.

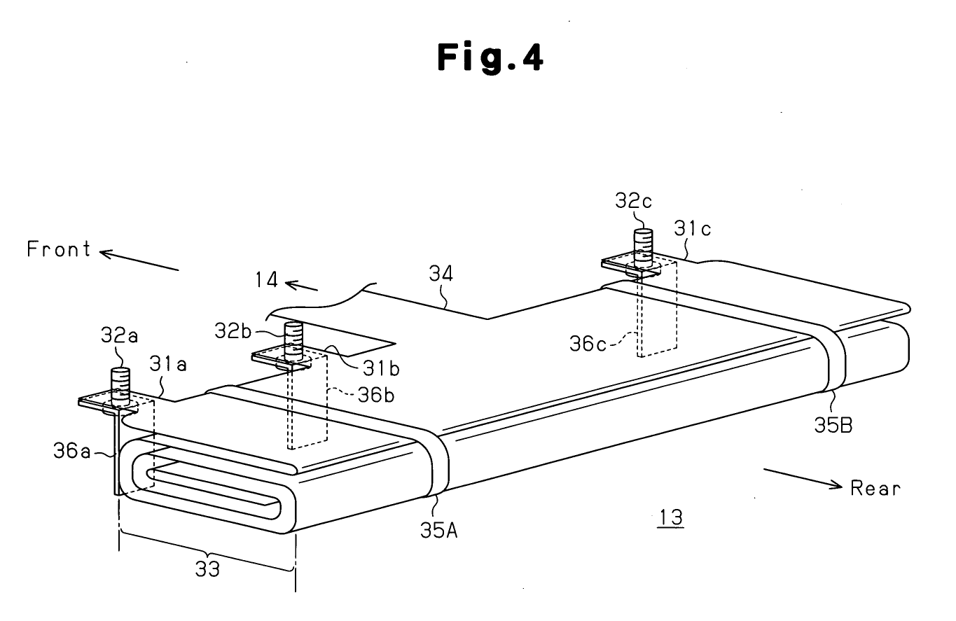

As illustrated in FIG. 4, the airbag body 13 is formed by a ground fabric such as a non-woven fabric. The airbag body 13 has the three rectangular fixed pieces 31a to 31c (a left fixed piece 31a, a central fixed piece 31b, and a right fixed piece 31c in this order from the left of the drawing), a folded portion 33, and a connecting portion 34. The folded portion 33 extends from the fixed pieces 31 and is maintained in a folded state. The connecting portion 34 connects the proximal end of the folded portion 33 to the gas supply port of the inflator 14.

When the airbag body 13 is fixed to the guide portion 23b of the inner panel 23, the folded portion 33 extends rearward from the fixed pieces 31a to 31c and is bent forward at a rear end. The folded portion 33 is then folded in a rolled state below the bent portion. Each of the fixed pieces 31a to 31c has a bolt bore (not shown) through which the corresponding one of the second bolts 32a to 32c (a left second bolt 32a, a central second bolt 32b, and a right second bolt 32c in this order from the left of FIG. 4). The left fixed piece 31a is arranged in the airbag body 13 at the left side of the vehicle 11. The right fixed piece 31c is provided in the airbag body 13 at the right side of the vehicle 11. The central fixed piece 31b is arranged in the airbag body 13 at a position between the left fixed piece 31a and the connecting portion 34.

A left binding tape 35A is wound around the outer circumference of the folded portion 33 at a position between the left fixed piece 31a and the central fixed piece 31b, thus binding the folded portion 33. A right binding tape 35B is wound around the outer circumference of the folded portion 33 at a position between the connecting portion 34 and the right fixed piece 31c, thus binding the folded portion 33. The binding tapes 35A, 35B maintain the airbag body 13 in the folded state when the airbag body 13 is secured to the guide portion 23b of the inner panel 23 (the roof panel 21). Deployment and inflation of the airbag body 13 cause rupture of the binding tapes 35A, 35B, thus releasing the folded portion 33. In a fully deployed and inflated state, the folded portion 33 has a substantially rectangular bag-like shape as illustrated in FIG. 2.

As has been described, the airbag body 13 has the fixed pieces 31a to 31c, which are fixed to the inner panel 23 (the roof panel 21) by the second bolts 32a to 32c, and the folded portion 33, which extends from the fixed pieces 31a to 31c and is held in the folded state. The airbag body 13 is supported by the inner panel 23 through the fixed pieces 31a to 31c, which are the front portions of the airbag body 13. Thus, when the airbag body 13 is fixed to the roof panel 21, the folded portion 33 may hang down due to its own weight.

To solve this problem, in the first embodiment, L-shaped restricting plates (a left restricting plate 36a, a central restricting plate 36b, and a right restricting plate 36c, in this order from the left of FIG. 4), which will be explained below, are provided between the heads of the second bolts 32a to 32c and the corresponding fixed pieces 31a to 31c. This structure prevents the folded portion 33 from hanging down.

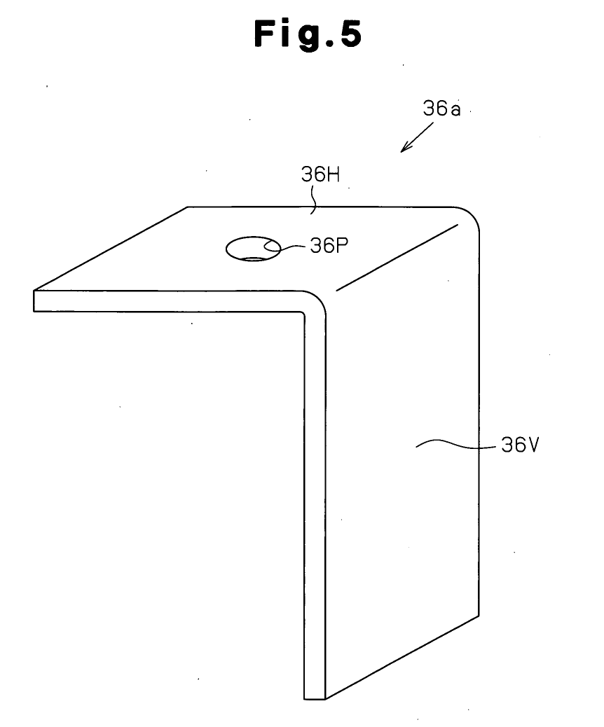

With reference to FIGS. 4 and 5, the restricting plates 36a to 36c are shaped identically. Thus, the following description focuses on the left restricting plate 36a, and explanations of the restricting plates 36b, 36c will be omitted.

As shown in FIG. 5, a restricting plate 36a is formed by bending a plate of steel. The restricting plate 36 has a reinforcing plate portion 36H and a contact plate portion 36V. The reinforcing plate portion 36H has a rectangular shape in correspondence with the fixed piece 31a of the airbag body 13. The contact plate portion 36V is bent substantially in a vertical direction at the rear end of the reinforcing plate portion 36H and extends downward. A bolt hole 36P is formed in the center of the reinforcing plate portion 36H to receive the second bolt 32. The contact plate portion 36V of the restricting plate 36 corresponds to a contact portion of a restricting member according to the present invention.

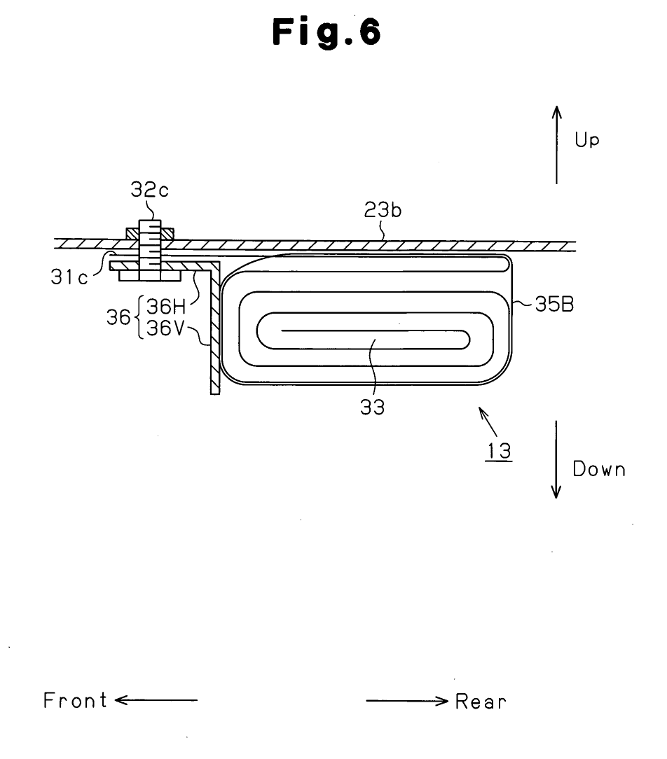

As illustrated in FIG. 6, the opposed surface (the left surface as viewed in the drawing) of the folded portion 33 opposed to the second bolt 32c is held in contact with the contact plate portion 36V. The lower end of the contact plate portion 36V is located downward from the lower end of the opposed surface of the folded portion 33.

When the airbag body 13 is fixed to the guide portion 23b (the roof panel 21) of the inner panel 23, the folded portion 33 acts to pivot the folded portion 33 due to its own weight about the fixed piece 31 serving as a fulcrum, causing the folded portion 33 to hang down. However, the contact plate portion 36V of the restricting plate 36, which is located at a position on a pivotal path of the folded portion 33, prevents the folded portion 33 from hanging down. The roof head lining 22 guides the airbag body 13 when the airbag body 13 is deployed and inflated. The roof head lining 22 is the only component located below the folded portion 33 with reference to FIG. 3, and there is an open space below the folded portion 33. Thus, downward deployment and inflation of the airbag body 13 are not hindered by the restricting plate 36.

If the contact plate portion 36V is held in contact solely with an upper end of the opposed surface of the folded portion 33, the portion (the right portion as viewed in FIG. 6) of the folded portion 33 spaced from the restricting plate 36 may pivot about the lower end of the contact plate portion 36V, which serves as a fulcrum, and hang down due to the own weight. However, in the first embodiment, the opposed surface of the folded portion 33 contacts the contact plate portion 36V of the restricting plate 36 along the entire length in vertical direction of the folded portion 33. This suppresses downward hanging of the folded portion 33.

The airbag apparatus according to the first embodiment of the present invention has the following advantages.

(1) The airbag apparatus has the binding tapes 35A, 35B, which bind the folded portion 33 of the airbag body 13 together and release the airbag body 13 when the airbag body 13 is deployed and inflated. This structure maintains the airbag body 13 in the folded state when the airbag apparatus is secured to the inner panel 23 (the roof panel 21).

(2) The airbag apparatus has the restricting plates 36 each having the contact plate portion 36V, which contacts the surface of the folded portion 33 opposed to the second bolts 32a to 32c when the airbag body 13 is fixed to the inner panel 23 (the roof panel 21). Thus, if the folded portion 33 is to pivot about the fixed pieces 31a to 31c serving as fulcrums and hang down, the restricting plates 36 arranged on the pivotal path of the folded portion 33 prevent the folded portion 33 from hanging down. Further, since the restricting plates 36 have the L shapes, the space below the folded portion 33 is open. Downward deployment and inflation of the airbag body 13 are thus prevented from being hindered by the restricting plates 36. This allows the airbag body 13 to be deployed and inflated substantially in a horizontal direction along the corresponding inner walls of the vehicle, proceed beyond the rearmost seat 16, and be smoothly deployed and inflated downward. Also, the airbag body 13 is prevented from hanging down when the airbag apparatus is installed.

(3) When the airbag body 13 is fixed to the inner panel 23 (the roof panel 21), the opposed surface (the left surface as viewed in FIG. 6) of the folded portion 33 contacts the contact plate portions 36V of the restricting plates 36 along the entire length in the vertical direction. This prevents each of the portions (the right portion as viewed in FIG. 6) of the folded portion 33 spaced from the corresponding restricting plates 36 from pivoting about the lower end of the associated contact plate portion 36V, the support point, and hanging down due to its own weight.

(4) The fixed pieces 31a to 31c of the airbag body 13 are fixed to the inner panel 23 (the roof panel 21) by the second bolts 32a to 32c through the reinforcing plate portions 36H of the restricting plates 36. In this manner, the restricting plates 36 function also as reinforcing plates reinforcing the fixed pieces 31a to 31c of the airbag body 13. This makes it unnecessary to provide a restricting member restricting downward displacement of the folded portion 33 while maintaining an open space below the folded portion 33 or fixing means fixing the restricting member to the vehicle, in addition to the restricting plates 36 serving as the reinforcing plates. As a result, the number of the components is prevented from being increased by the restricting member or the fixing means.

### Second Embodiment

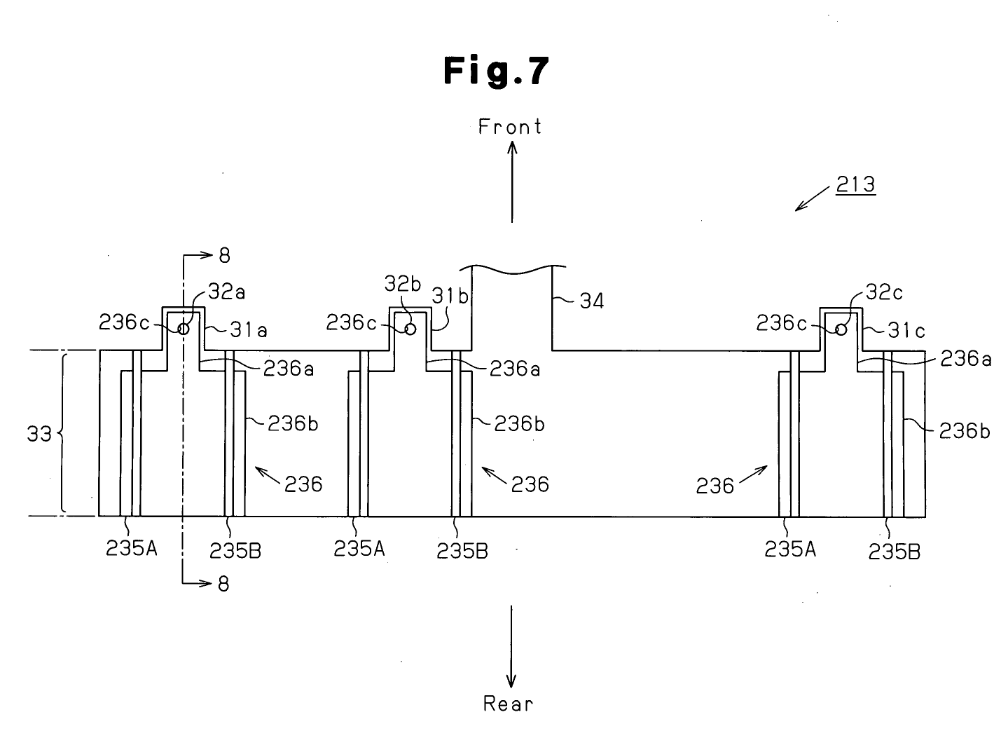

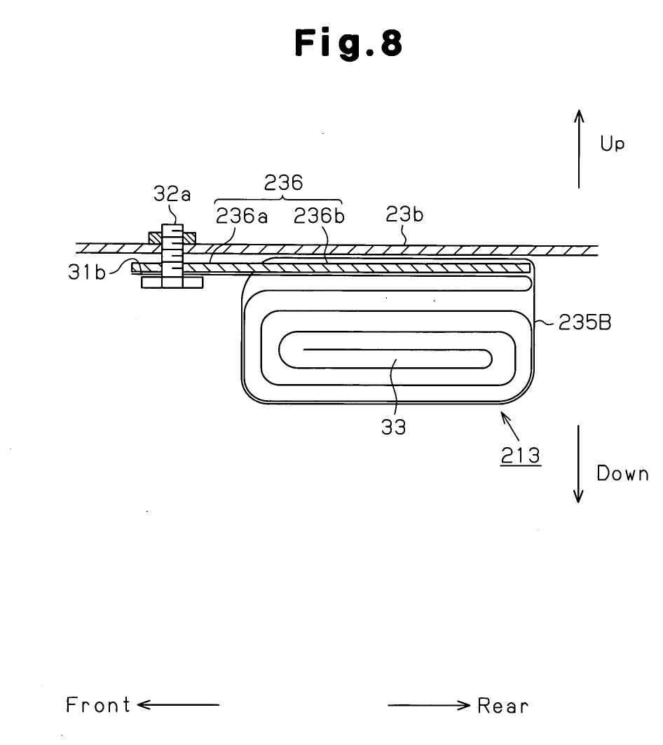

An airbag apparatus according to a second embodiment of the present invention will hereafter be described with reference to FIGS. 7 and 8. The description focuses on the differences between the second embodiment and the first embodiment.

As shown in FIG. 7, in the second embodiment, T-shaped restricting plates 236 are arranged above the fixed pieces 31a to 31c of an airbag body 213. This structure prevents the folded portions 33 from hanging down. The restricting plates 236 are shaped identically.

Each of the T-shaped restricting plates 236 is formed by a flat plate of steel. Each of the restricting plates 236 has a proximal portion 236a and a support plate portion 236b. The proximal portion 236a has a rectangular shape in correspondence with each of the fixing plates 31a to 31c of the airbag body 213. The support plate portion 236b has a rectangular shape and extends from the proximal portion 236a in a rearward direction (downward as viewed in FIG. 7) and in the direction of the width of the vehicle (the left-and-right direction as viewed in the drawing).

Each of the proximal portions 236a has a bolt hole 236c through which the corresponding one of the second bolts 32a to 32c is passed. A left binding tape 235A is wound around the outer circumference of each of the support plate portions 236b and the folded portion 33 at a position at the left side of the associated one of the fixed pieces 31a to 31c. This binds the support plate portion 236b and the folded portion 33 together. A right binding tape 235B is wound around the outer circumference of each support plate portion 236b and the folded portion 33 at a position at the right side of the associated fixed piece 31a, 31b, 31c. This binds the support plate portion 236b and the folded portion 33 together.

The binding tapes 235A, 235B maintain the airbag body 13 in the folded state when the airbag body 213 is secured to the guide portion 23b of the inner panel 23 (the roof panel 21). The binding tapes 235A, 235B break and release the airbag body 213 when the airbag body 213 is deployed and inflated. In a fully deployed and inflated state, the folded portion 33 has a substantially rectangular bag-like shape as illustrated in FIG. 2. The support plate portion 236b of each restricting plate 236 corresponds to a support portion of a restricting member according to the present invention.

With reference to FIG. 8, the length of the support plate portion 236b of each restricting plate 236 is smaller than the width of the folded portion 33 in the front-and-rear direction. Thus, on the upper surface of the folded portion 33, each support plate portion 236b extends from the rear end to a position in the vicinity of the front end of the folded portion 33, instead of extending to the front end.

In this structure, when the airbag body 213 is fixed to the guide portion 23b of the inner panel 23 (the roof panel 21), the folded portion 33 is supported by the support plate portions 236b of the restricting plates 236, which are arranged above the folded portion 33, through the binding tapes 235A, 235B. The folded portion 33 is thus prevented from hanging down. The roof head lining 22 guides the airbag body 213 when the airbag body 213 is deployed and inflated. Since the roof head lining 22 is the sole component located below the folded portion 33, the space below the folded portion 33 is open. Thus, downward deployment and inflation of the airbag body 213 are not hindered by the restricting plates 236.

If the support plate portion 236b of each restricting plate 236 is formed only by a portion located close to the corresponding fixed piece 31a to 31c above the folded portion 33, a rear portion (a right portion as viewed in FIG. 8) of the folded portion 33 spaced from the corresponding fixed piece 31a to 31c may hang down due to the own weight. However, in the second embodiment, the support plate portion 236b of each restricting plate 236 supports the upper surface of the folded portion 33 substantially along the entire length in the front-and-rear direction. The folded portion 33 is thus prevented from hanging down.

The airbag apparatus according to the second embodiment has the following advantages.

(1) The airbag apparatus has the binding tapes 235A, 235B, which bind the folded portion 33 of the airbag body 213 together and release the airbag body 213 when the airbag body 213 is deployed and inflated. This structure maintains the airbag body 213 in the folded state when the airbag apparatus is secured to the inner panel 23 (the roof panel 21).

(2) The airbag apparatus has the restricting plates 236, which are located above the folded portion 33 and bound with the folded portion 33 by the binding tapes 235A, 235B when the airbag body 213 is fixed to the inner panel 23 (the roof panel 21). Thus, with the airbag body 213 fixed to the inner panel 23 (the roof panel 21), the folded portion 33 is supported by the support plate portions 236b of the restricting plates 236, which are arranged above the folded portion 33, through the corresponding binding tapes 235A, 235B. This prevents the folded portion 33 from hanging down. Further, since the restricting plates 236 ensure an open space below the folded portion 33, downward deployment and inflation of the airbag body 213 are prevented from being hindered by the restricting plates 236. Accordingly, while allowing the airbag body 213 to be smoothly deployed and inflated downward along the opposed inner walls of the vehicle, the airbag body 213 is prevented from hanging down when the airbag apparatus is installed.

(3) The support plate portion 236b of each restricting plate 236 supports the folded portion 33 along the entire length in the front-and-rear direction of the upper surface of the folded portion 33, with the airbag body 213 fixed to the inner panel 23 (the roof panel 21). This prevents the rear portion of the folded portion 33 spaced from the fixed pieces 31a to 31c from hanging down due to the own weight. In other words, hanging down of the folded portion 33 is suppressed along the entire length in the front-and-rear direction.

### Third Embodiment

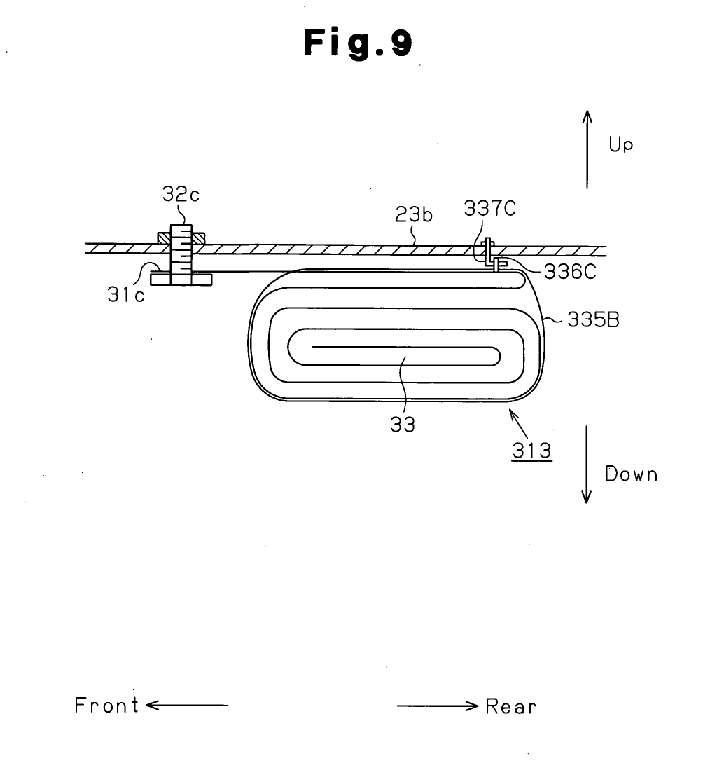

An airbag apparatus according to a third embodiment of the present invention will now be described with reference to FIG. 9. The following description focuses on the differences between the third embodiment and the first and second embodiments.

As shown in FIG. 9, left and right binding tapes 335B are wound around the outer circumference of the folded portion 33 to bind the folded portion 33 together, as in the first embodiment. The binding tapes 335B maintain the airbag body 313 in a folded state when an airbag body 313 is secured to the guide portion 23b of the inner panel 23 (the roof panel 21). When the airbag body 313 is deployed and inflated, the binding tapes 335B break to release the airbag body 313. In a fully deployed and inflated state, the folded portion 33 has a substantially rectangular bag-like shape as shown in FIG. 2.

When the airbag body 313 is fixed to the guide portion 23b of the inner panel 23 (the roof panel 21), a ring 336c is secured to a rear portion of the upper surface of the folded portion 33. A hook 337, which is formed in correspondence with the ring 336 and is opened rearward, is fixed to the lower surface of the guide portion 23b. The hook 337 is engaged with the annular opening of the ring 336 in such a manner that the folded portion 33 is supported by the inner panel 23.

Specifically, three pairs of the rings 336 and the corresponding hooks 337 are provided in correspondence with the fixed pieces 31a, 31b, 31c and aligned in the direction along the width of the vehicle. It is preferable that the numbers and the locations of the rings 336 and the hooks 337 be set as needed so that the folded portion 33 is supported in a stable state. The rings 336 and the hooks 337 correspond to restricting members of the present invention.

In this configuration, when the airbag body 313 is fixed 10 to the guide portion 23b of the inner panel 23 (the roof panel 21), the folded portion 33 is supported by the inner panel 23 (the roof panel 21) through the rings 336 and the hooks 337. Downward displacement of the folded portion 33 is thus restricted. The roof head lining 22 guides the airbag body 313 when the airbag body 313 is deployed and inflated. The roof head lining 22 is the only component located below the folded portion 33 and an open space is ensured below the folded portion 33. Thus, downward deployment and inflation of the airbag body 313 are not hindered by the rings 336 and the hooks 337.

If downward displacement of the folded portion 33 is restricted, such restriction may hamper deployment and inflation of the airbag body 313. However, in the third embodiment, the rings 336 move rearward and separate from the corresponding hooks 337 when the airbag body 313 is deployed and inflated. Deployment and Inflation of the airbag body 313 are not hindered by the rings 336 and the hooks 337.

The airbag apparatus according to the third embodiment has the following advantages.

(1) The airbag apparatus has the binding tapes 235B, which bind the folded portion 33 of the airbag body 313 together and release the folded portion 33 when the airbag body 313 is deployed and inflated. Thus, when the airbag apparatus is secured to the inner panel 23 (the roof panel 21), the airbag body 313 is held in a folded state.

(2) The airbag apparatus has the rings 336 and the hooks 337, which restrict downward displacement of the folded portion 33 while ensuring an open space below the folded portion 33 when the airbag body 313 is fixed to the inner panel 23 (the roof panel 21). The folded portion 33 is thus prevented from hanging down. The open space below the folded portion 33 prevents downward deployment and inflation of the airbag body 313 from being hindered by the rings 336 and the hooks 337. Thus, while allowing the airbag body 313 to be smoothly deployed and inflated downward along the inner walls of the vehicle, the airbag body 313 is prevented from hanging down when the airbag apparatus is installed.

(3) The rings 336 and the hooks 337 release the airbag body 313 from the restricted state when the airbag body 313 is deployed and inflated. Deployment and inflation of the airbag body 313 are thus prevented from being hindered by the rings 336 and the hooks 337.

### Fourth Embodiment

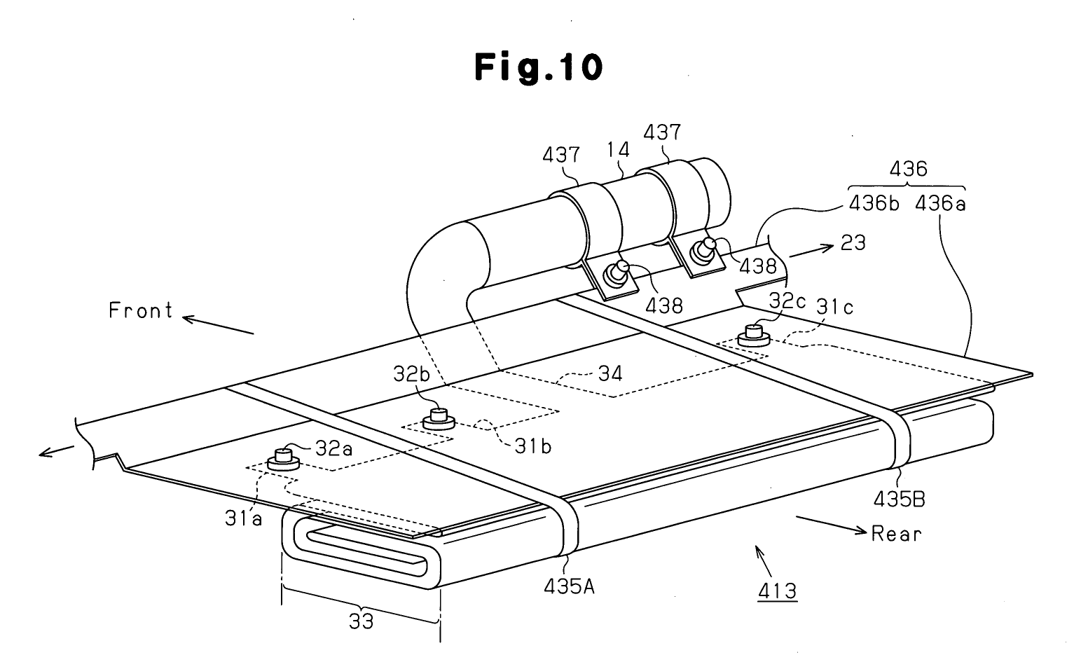

An airbag apparatus according to a fourth embodiment of the present invention will now be described with reference to FIG. 10. The following description focuses on the difference between the fourth embodiment and the first to third embodiments.

As shown in FIG. 10, in the fourth embodiment, a restricting retainer 436 is arranged above an airbag body 413, thus preventing the folded portion 33 from hanging down.

The restricting retainer 436 is formed by bending a plate of steel. The restricting retainer 436 has a flat plate-like support retainer portion 436a and a fixing retainer portion 436b. The support retainer portion 436a covers the entire zone above the folded portion 33 and the fixed pieces 31a to 31c. The fixing retainer portion 436b is bent at a predetermined angle at the front end (the left end as viewed in FIG. 10) of the support retainer portion 436a, and extends upward.

The fixed pieces 31a to 31c of the airbag body 413 are fixed to the support retainer portion 436a through the second bolts 32a to 32c. The inflator 14 is fixed to the fixing retainer portion 436b through metal holders 437 and third bolts 438. A pair of brackets (not shown) are provided at both ends of the fixing retainer portion 436b in the direction of the width. The brackets are secured to the slanted portion 23a of the inner panel 23, which is shown in FIG. 3.

A left binding tape 435A is wound around the outer circumference of the restricting retainer 436 and the folded portion 33 and at the left side of the connecting portion 34. This binds the restricting retainer 436 and the folded portion 33 together. A right binding tape 435B is wound around the outer circumference of the restricting retainer 436 and the folded portion 33 and at the right side of the connecting portion 34. This binds the restricting retainer 436 and the folded portion 33 together. The binding tapes 435A, 435B maintain the airbag body 413 in a folded state when the airbag body 413, along with the restricting retainer 436, is secured to the slanted portion 23a of the inner panel 23 (the roof panel 21). When the airbag body 413 is deployed and inflated, the binding tapes 435A, 435B break and release the airbag body 413. In a fully deployed and inflated state, the folded portion 33 has a substantially rectangular bag-like shape as illustrated in FIG. 2. The support retainer portion 436a of the restricting retainer 436 corresponds to a support portion of a restricting member according to the present invention.

Thus, when the airbag body 413 is fixed to the slanted portion 23a of the inner panel 23 (the roof panel 21), the folded portion 33 is supported by the support retainer portion 436a of the restricting retainer 436, which is located above the folded portion 33, through the binding tapes 435A, 435B. The folded portion 33 is thus prevented from hanging down. The roof head lining 22 guides the airbag body 413 when the airbag body 413 is deployed and inflated. Since the roof head lining 22 is the sole component located below the folded portion 33, an open space is ensured below the folded portion 33. Thus, downward deployment and inflation of the airbag body 413 are not hindered the restricting retainer 436.

If the support retainer portion is provided restrictedly to a central portion of the folded portion 33 in a direction perpendicular to the deploying and inflating direction, or the direction of the width of the vehicle, both ends of the folded portion 33 (in the width direction of the vehicle) may hang down due to the own weight. However, in the fourth embodiment, the support retainer portion 436a of the restricting retainer 436 supports the upper surface of the folded portion 33 along the entire length in the width direction of the vehicle. Thus, the folded portion 33 is prevented from hanging down.

The airbag apparatus according to the fourth embodiment of the present invention has the following advantages.

(1) The airbag apparatus has the binding tapes 435A, 435B, which bind the folded portion 33 of the airbag body 413 together and release the folded portion 33 when the airbag body 413 is deployed and inflated. The airbag body 413 is thus maintained in a folded state when the airbag apparatus is secured to the inner panel 23 (the roof panel 21).

(2) The airbag apparatus has the restricting retainer 436, which is located above the folded portion 33 and bound with the folded portion 33 by the binding tapes 435A, 435B when the airbag body 413 is fixed to the inner panel 23 (the roof panel 21). Thus, with the airbag body 413 fixed to the inner panel 23 (the roof panel 21), the folded portion 33 is supported by the support retainer portion 436a of the restricting retainer 436, which is located above the folded portion 33, through the binding tapes 435A, 435B. This prevents the folded portion 33 from hanging down. Further, since the restricting retainer 436 ensures an open space below the folded portion 33, downward deployment and inflation of the airbag body 413 are prevented from being hindered by the restricting retainer 436. Accordingly, while allowing the airbag body 413 to be smoothly deployed and inflated downward along the inner walls of the vehicle, the airbag body 413 is prevented from hanging down when the airbag apparatus is installed.

(3) When the airbag body 413 is fixed to the inner panel 23 (the roof panel 21), the support retainer portion 436a of the restricting retainer 436 supports the upper surface of the folded portion 33 along the entire length in the width direction of the vehicle. This prevents both ends of the folded portion 33 in the width direction of the vehicle from hanging down due to the weight of the folded portion 33. In other words, the folded portion 33 is prevented from hanging down along the entire length in the width direction of the vehicle.

The airbag apparatus according to the present invention is not restricted to the illustrated embodiments but may be embodied in, for example, the following modified forms as needed.

In the illustrated embodiments, when the airbag body 13 is fixed to the inner panel 23, the folded portion 33 extends rearward from the fixed pieces 31a to 31c and is bent forward at the rear end. The folded portion 33 is then folded in a rolled state below the bent portion. However, the folded portion 33 may be folded in any other suitable manner. For example, with the airbag body 13 fixed to the inner panel 23, the folded portion 33 may extend rearward from the fixed pieces 31a to 31c and be bent forward at the rear end and then rearward at the front end. The folded portion 33 is then folded in a rolled state below the bent portions. In other words, the folded portion 33 may be bent for a plurality of times. Further, the folded portion 33 does not necessarily have to be folded in the rolled state but may be folded in any other suitable state as necessary.

In the first embodiment, the length of the contact plate portion 36V of each of the L-shaped restricting plates 36a to 36b in the vertical direction is set in such a manner that the contact plate portion 36V contacts the opposed surface (the left surface as viewed in FIG. 6) of the folded portion 33 along the entire length in the vertical direction, with the airbag body 13 fixed to the inner panel 23 (the roof panel 21). However, such length of the contact plate portion 36V may be decreased as long as the length falls in the range that prevents the folded portion 33 from hanging down.

In the first embodiment, the three restricting plates 36a to 36c are provided in correspondence with the fixing plates 31a to 31c. However, the contact plate portions of the restricting plates may be connected together so that the contact plate portions contact the opposed surface of the folded portion 33 along the entire length in the width direction of the vehicle.

In the second embodiment, the length of the support plate portion 236b of each T-shaped restricting plate 236 in the front-and-rear direction is set in such a manner that the support plate portion 236b supports the upper surface of the folded portion 33 along the entire length in the front-and-rear direction when the airbag body 13 is fixed to the inner panel 23 (the roof panel 21). However, such length of the support plate portion 236b may be decreased as long as the length falls in the range that prevents the folded portion 33 from hanging down.

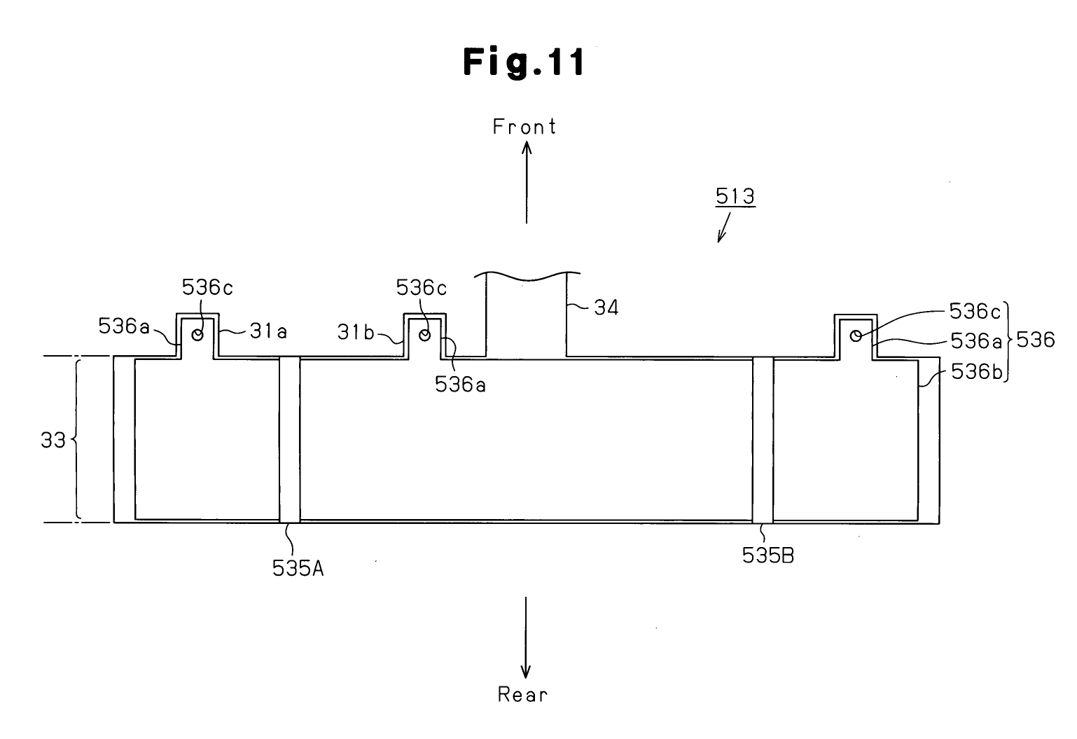

In the second embodiment, the three restricting plates 236 are provided in correspondence with the fixed pieces 31a to 31c. However, the support plate portions 236b of the restricting plates 236 may be connected together. In this manner, as illustrated in FIG. 11, the upper surface of the folded portion 33 is supported along the entire length in the width direction of the vehicle. In this case, a restricting plate 536 includes three rectangular proximal portions 526a corresponding to the fixed pieces 31a to 31c and a single rectangular support plate portion 536b. The support plate portion 536b extends rearward (downward as viewed in FIG. 11) from the proximal portions 536a and then in the width direction of the vehicle (in the left-and-right direction of the drawing). Further, a bolt hole 536c is formed in each of the proximal portions 536a to receive the corresponding one of the second bolts 32a to 32c. Further, binding tapes 535A, 535B are wound around the outer circumference of the support plate portion 536b and the folded portion 33.

In the third embodiment, the rings 336 and the hooks 337 are used to restrict the airbag body 313. When the airbag body 313 is deployed and inflated, the rings 336 and the hooks 337 release the airbag body 313 from such restriction. However, any other suitable configuration may be employed to ensure an open space below the folded portion 33 and restrict downward displacement of the folded portion 33 when the airbag body 313 is fixed to the roof panel 21 but release the airbag body 313 when the airbag body 313 is deployed and inflated. For example, a pair of surface fasteners may be secured to the upper surface of the folded portion 33 and the opposing lower surface of the inner panel 23.

In the third embodiment, the rings 336 and the hooks 337 release the airbag body 313 from its restricted state when the airbag body 313 is deployed and inflated. However, if deployment and inflation of the airbag body 313 are not hindered by the rings 336 or the hooks 337, the airbag body 313 may be maintained in the restricted state when being deployed and inflated.

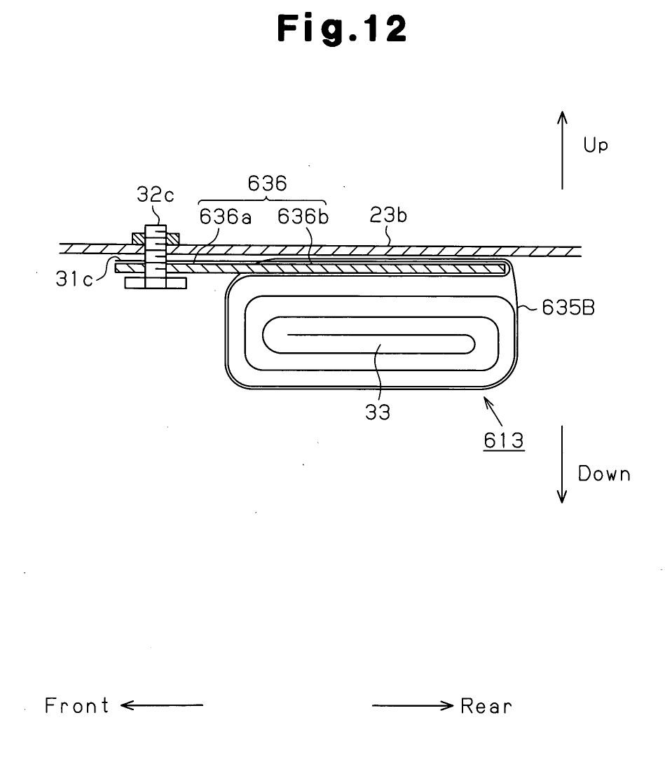

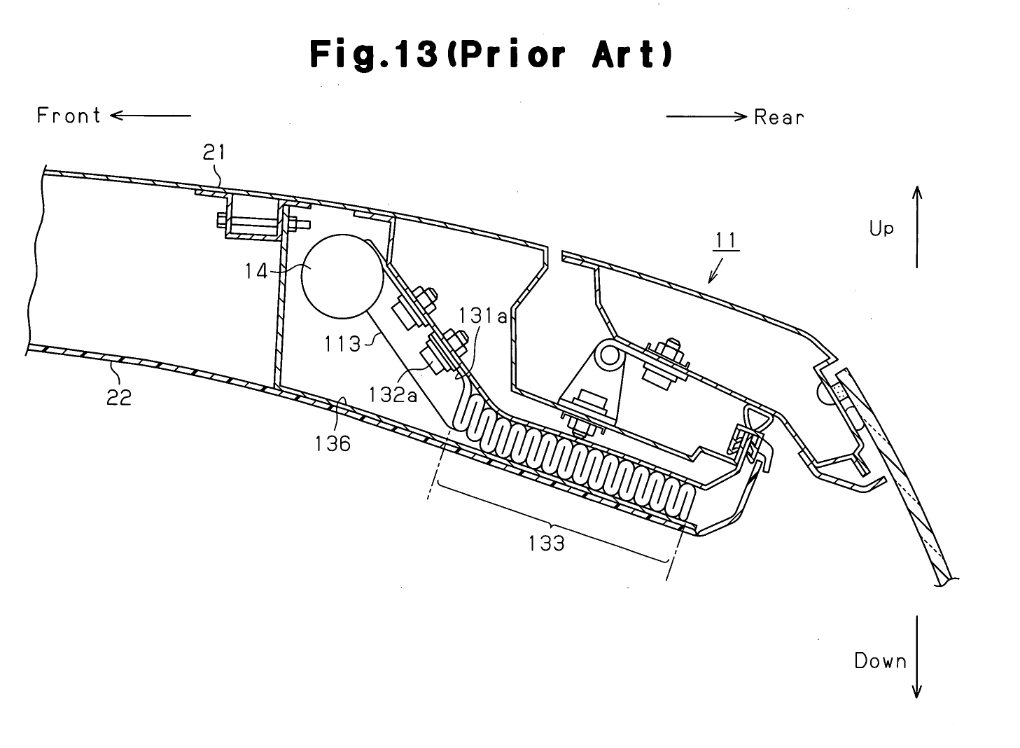

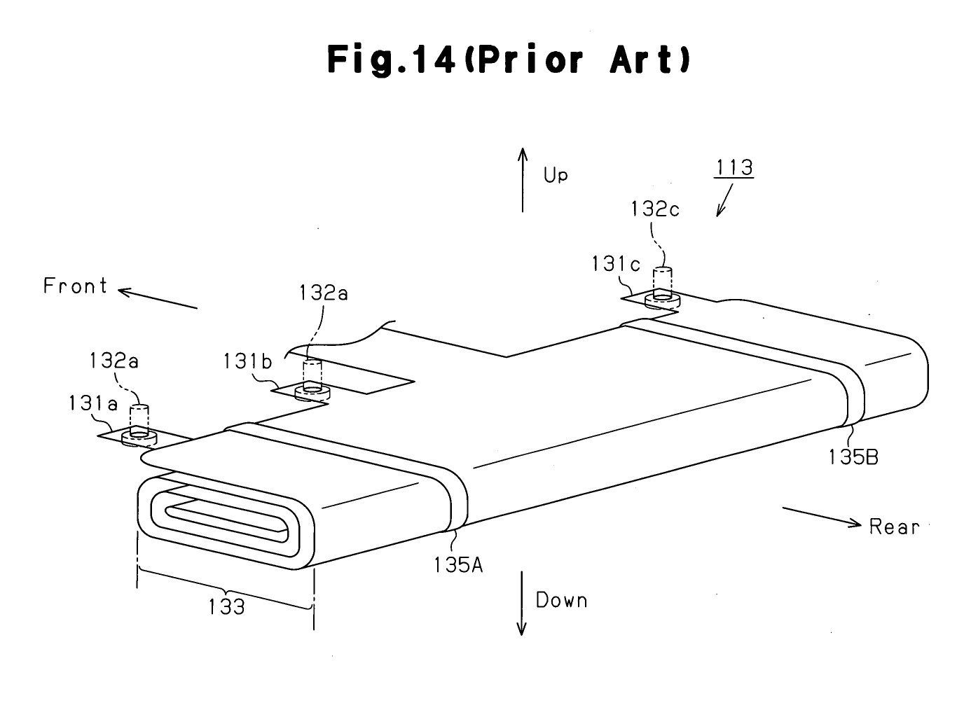

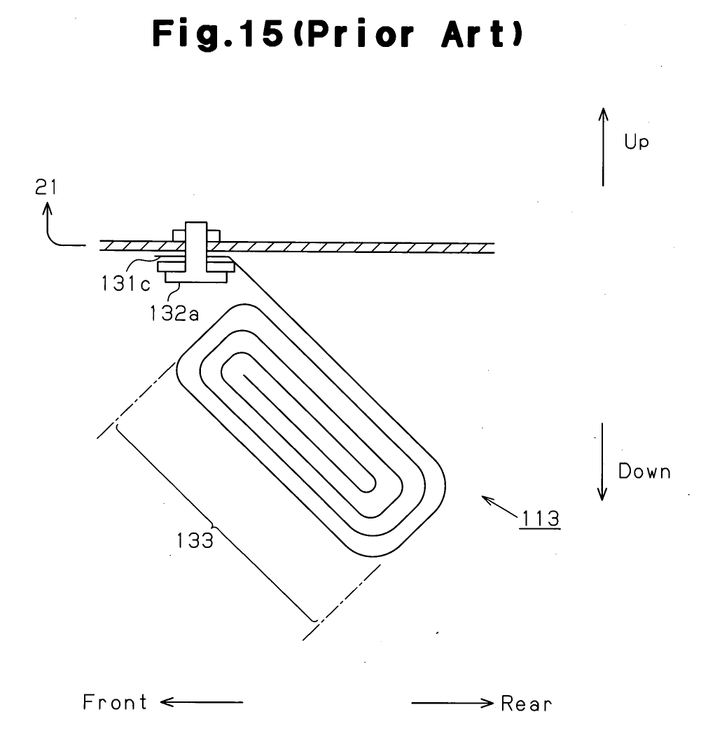

Alternatively, as illustrated in FIG. 12, the folded portion 33 may be formed by extending an airbag body 613 rearward from the fixed pieces 31c, and bending the airbag body 613 forward at a rear end with the airbag body 613 fixed to the guide portion 23b of the inner panel 23 (the roof panel 21). In this case, an opening is formed in the front surface of the folded portion 33 between the uppermost section of the folded portion 33 and the section immediately below the uppermost section. Thus, a support plate portion 636b of a restricting plate 636 shaped identically with the restricting plate 236 of the second embodiment is passed through the opening. In this structure, each fixed piece 31a to 31c of the airbag body 613 is fixed to the guide portion 23b of the inner panel 23 by the second bolt 32c through a proximal portion 636a of the restricting plate 636. The restricting plate 636 functions also as a reinforcing plate that reinforces the corresponding fixed piece 31a to 31c of the airbag body 613.

In each of the illustrated embodiments, the second bolts 32a to 32c are used as fixing members that fix the airbag body to the inner panel 23 (the roof panel 21). However, the fixing members may be configured in any other suitable manner. As long as the fixing members fix the airbag body to the inner panel 23 (the roof panel 21), the fixing members may be modified in any suitable manner. Further, as fixed portions fixed by the fixing members, the fixed pieces 31a to 31c are employed. However, the fixed portions may be constituted in any other suitable manner and modified as needed as long as the fixed portions are fixed by the fixing members.

In each of the illustrated embodiments, the binding tapes are used as binding members that bind the folded portion 33 together and release the folded portion 33 when the airbag body is deployed and inflated. However, the binding members may be configured in any other suitable form. That is, the binding members may be formed by, for example, strings.

In each of the illustrated embodiments, the airbag body is secured to the inner panel 23. However, instead of this, the airbag body may be secured directly to the roof panel 21. In other words, as long as the airbag body is fixed to the roof panel, any other suitable structure may be employed.

Although the present invention is embodied as the airbag apparatus for rear-end collision in each of the illustrated embodiments, the invention is not restricted to this. The present invention may be embodied as airbag apparatus for side collision or front collision. In other words, as long as an airbag body is mounted between a roof panel of a vehicle and a roof head lining and held in a folded state, the invention may be embodied as any suitable form of airbag apparatus.

1. An airbag apparatus having an airbag body arranged between a roof panel and a roof head lining of a vehicle and held in a folded state, the airbag apparatus comprising:
a fixing member fixing the airbag body to the roof panel;
the airbag body having a fixed portion fixed by the fixing member and a folded portion that extends from the fixed portion and is maintained in a folded state;
a binding member binding the folded portion in the folded state and releasing the folded portion when the airbag body is deployed and inflated; and
a restricting member that restricts downward displacement of the folded portion when the airbag body is fixed to the roof panel.

2. The apparatus according to claim 1, wherein the restricting member has a contact portion that contacts an opposed surface of the folded portion that is opposed to the fixing member.

3. The apparatus according to claim 2, wherein the contact portion of the restricting member contacts a portion corresponding to a lower end of the opposed surface when the airbag body is fixed to the roof panel.

4. The apparatus according to claim 1, wherein, when the airbag body is fixed to the roof panel, the restricting member has a support portion located above the folded portion and is bound with the folded portion by the binding member.

5. The apparatus according to claim 4, wherein, when the airbag body is fixed to the roof panel, the support portion of the restricting member is provided on an upper surface of the folded portion along the entire length in a direction perpendicular to a deploying and inflating direction of the airbag body.

6. The apparatus according to claim 4, wherein, when the airbag body is fixed to the roof panel, the support portion of the restricting member is shorter than the width of the folded portion in a front-and-rear direction.

7. The apparatus according to claim 1, wherein the fixed portion of the airbag body is fixed to the roof panel by the fixing member through the restricting member.

8. The apparatus according to claim 1, wherein the restricting member releases the folded portion from a restricted state when the airbag body is deployed and inflated.

9. The apparatus according to claim 1, wherein the airbag apparatus is an airbag apparatus for rear-end collision, and wherein the airbag body is deployed and inflated into a space rearward from a rear seat of the vehicle.

10. The apparatus according to claim 9, wherein the airbag body is deployed and inflate substantially in a horizontal direction at a position above the rear seat before being deployed and inflated into a space rearward from the rear seat.

11. An airbag apparatus having an airbag body arranged between a roof panel and a roof head lining of a vehicle and held in a folded state, the airbag apparatus comprising:
a fixing member fixing the airbag body to the roof panel;
the airbag body having a fixed portion fixed by the fixing member and a folded portion that extends from the fixed portion and is maintained in a folded state;
a binding member binding the folded portion in the folded state and releasing the folded portion when the airbag body is deployed and inflated; and
a restricting member that restricts downward displacement of the folded portion 1. An airbag apparatus having an airbag body arranged between a roof panel and a roof head lining of a vehicle and held in a folded state, the airbag apparatus comprising:
a fixing member fixing the airbag body to the roof panel;
the airbag body having a fixed portion fixed by the fixing member and a folded portion that extends from the fixed portion and is maintained in a folded state;
a binding member binding the folded portion in the folded state and releasing the folded portion when the airbag body is deployed and inflated; and
a restricting member that restricts downward displacement of the folded portion while ensuring an open space below the folded portion when the airbag body is fixed to the roof panel.
